(19) United States
(12) Patent Application Publication
(10) Pub. No.: US 2026/0304402 A1
(43) Pub. Date: Oct. 1, 2026

(54) TERMINAL DEVICE

(71) Applicant: SK TELECOM CO., LTD., Seoul (KR)

(72) Inventors: Sang Hoon CHO, Seoul (KR); Seong Kyun SEO, Seoul (KR)

(21) Appl. No.: 19/490,110

(22) PCT Filed: Jul. 29, 2024
(86) PCT No.: PCT/KR2024/011028

§ 371 Date: Dec. 4, 2025

(30) Foreign Application Priority Data
Aug. 9, 2023 (KR) 10-2023-0104177

(51) Int. Cl. H04W 72/0453; H04B 7/06; H04L 25/02

(52) U.S. Cl. CPC H04W 72/0453; H04B 7/0626; H04L 25/0224

(57) ABSTRACT

The present disclosure relates to a subband non-overlapping full duplex (SBFD) technology and, more particularly, to a method for dynamically allocating a resource for CSI-RS transmission in a communication environment in which simultaneous transmission of downlink and uplink between frequency subbands is supported.

### TECHNICAL FIELD

The present disclosure relates to a subband non-overlapping full duplex (SBFD) technology and, more particularly, to a method for dynamically allocating a resource for CSI-RS transmission in a communication environment that supports simultaneous transmission of downlink and uplink between frequency subbands.

This application claims priority to Korean Patent Application NO. 10-2023-0104177, filed on Aug. 9, 2023, in the Korean Intellectual Property Office, the disclosure of which is herein incorporated by reference in its entirety.

### BACKGROUND OF THE INVENTION

In new radio (NR), i.e., a 5G system, a technology enabling simultaneous transmission (Tx) and reception (Rx) using full duplex communication based on the existing TDD scheme is being discussed.

This is a technique for transmission of a downlink and an uplink separately by subband within a slot, and is referred to as subband non-overlapping full duplex (SBFD).

Meanwhile, in an SBFD-based communication environment in which simultaneous transmission of downlink and uplink between frequency subbands is supported as described above, a CSI-RS should be transmitted through the downlink to support channel estimation of the terminal device, as in the conventional scheme.

However, unlike the existing scheme in which the entire frequency domain of a slot is allocated as a resource for CSI-RS transmission, in the case of the SBFD scheme, the downlink and the uplink may coexist during the same time period. In addition, since the 5G system adopts a network slicing scheme that allows fine-grained differentiation of services, a new resource allocation scheme that can take these aspects into account is required.

### DETAILED DESCRIPTION OF THE INVENTION

### Technical Problems

The present disclosure has been made in view of the above-mentioned problems, and the present disclosure is to provide a technology related to subband non-overlapping full duplex (SBFD), which dynamically allocates a resource for CSI-RS transmission in a communication environment in which simultaneous transmission of uplink and downlink between frequency subbands is supported.

### Solution to the Problems

According to an embodiment of the present disclosure, a terminal device includes a memory configured to store instructions, and a processor configured to execute the instructions to, as simultaneous transmission of downlink and uplink between frequency subbands is supported, when a slot format is changed by a base station device based on a network slicing scheme of the terminal device, receive a CSI-RS transmitted by the base station device through a channel estimation resource configured in a downlink frequency domain in the slot format.

Specifically, for the terminal device, the slot format may include at least one of a downlink slot for downlink transmission and a simultaneous transmission slot for simultaneous transmission of downlink and uplink.

Specifically, the channel estimation resource may be allocated, for the downlink slot, to an entire frequency domain of the downlink slot on a slot basis, and may be allocated, for the simultaneous transmission slot, to a frequency domain for which the downlink is configured on a frequency subband basis within the slot.

Specifically, the channel estimation resource may be allocated in a manner of specifying a starting position of a frequency subband in which downlink is configured in the simultaneous transmission slot, and configuring the number of resources (RBs) required for CSI-RS transmission from the specified starting position.

Specifically, the channel estimation resource may be allocated to different frequency domains for which the downlink is configured in the slot format, based on the data usage of the terminal device, and in case that the data usage of the terminal device exceeds a threshold, the channel estimation resource may be allocated to an entire frequency domain including downlinks of the downlink slot and the simultaneous transmission slot.

### Effects of the Invention

In a terminal device of the present disclosure, which supports simultaneous transmission of downlink and uplink between frequency subbands, a slot format may be changed based on a network slicing scheme of the terminal device, and a frequency domain of a downlink configured for the terminal device in the slot format based on the data usage of the terminal device may be dynamically allocated, as channel estimation resources for CSI-RS transmission, thereby enabling efficient utilization of resources. Furthermore, since the resource is configured based on the data usage and the network slicing scheme of the terminal device, rather than using the entire resource of the base station device, power consumption of the base station device and the terminal device can be reduced.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is an illustrative diagram for describing a slot format of an SBFD scheme according to an embodiment of the present disclosure;

FIG. 2 is an illustrative diagram for describing a full-duplex communication environment based on SBFD according to an embodiment of the present disclosure;

FIG. 3 is an illustrative diagram for describing a configuration of a base station device according to an embodiment of the present disclosure;

FIGS. 4 and 5 are illustrative diagrams for describing a resource allocation scheme for CSI-RS transmission according to an embodiment of the present disclosure;

FIG. 6 is an illustrative diagram for describing a configuration of a UE device according to an embodiment of the present disclosure; and FIG. 7 is a flowchart for describing a dynamic resource allocation method according to an embodiment of the present disclosure.

### EMBODIMENTS OF THE INVENTION

Hereinafter, various embodiments of the present disclosure will be described with reference to the accompanying drawings.

The present disclosure relates to a subband non-overlapping full duplex (SBFD) technology.

Since the LTE system and the 5G system employ OFDM as a communication scheme, they operate based on similar standards.

However, whereas the LTE system mainly allows configuration in a fixed format, the 5G system enables dynamic configuration. In addition, unlike the LTE system, which employs the FDD communication method, the 5G system primarily uses the TDD method to increase bandwidth and improve frequency efficiency.

This TDD scheme is a half-duplex communication scheme, in which uplink signals cannot be transmitted while downlink signals are being transmitted. Furthermore, in order to increase the transmission speed, it is necessary to allocate more downlink resources than uplink resources, resulting in relatively fewer opportunities for uplink resource allocation.

In addition, in the case of a TDD scheme, when used in an environment that utilizes adjacent frequencies or the same frequency, the same slot format should be used.

For example, in South Korea, communication companies use the same DDDSU slot format under agreement.

If the slot formats are different for each operator or carrier, a case may occur in which, when a downlink is used by one operator or one base station, an uplink is used by another base station.

In this case, at a base station handling uplink signals, which have relatively lower transmission power, communication may become difficult due to interference from downlink signals transmitted by other base stations.

Furthermore, when different carriers use different frequencies, interference between adjacent frequency bands becomes inevitable when strong signals are transmitted.

In 3GPP, research on subband non-overlapping full duplex (SBFD) has been conducted to overcome the above-mentioned disadvantages of the TDD scheme.

In the case of the SBFD technology, downlink and uplink transmissions may be divided and transmitted by frequency subband within a slot through a full-duplex communication scheme that simultaneously uses downlink and uplink.

As a result, in SBFD technology, uplink resources can be allocated over consecutive slot intervals, thereby improving the aforementioned problems inherent in the conventional TDD scheme.

In the SBFD-based communication environment in which simultaneous transmission of downlink and uplink between frequency subbands is supported as described above, it is still essential to transmit a CSI-RS through the downlink in order to support channel estimation of a UE device, in the same way as in the existing scheme.

However, unlike the existing scheme in which the entire frequency domain of a slot is allocated as a resource for CSI-RS transmission, the SBFD scheme has a characteristic in which the downlink and uplink coexist during the same time period, and therefore, a new resource allocation scheme that takes this characteristic into account is required.

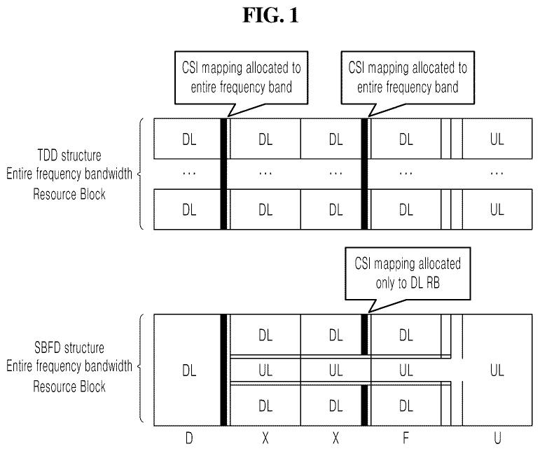

In other words, in the existing TDD scheme, for example, an entire frequency domain is necessarily allocated for CSI-RS transmission, as shown in FIG. 1.

On the other hand, since downlink and uplink coexist during the same time period in the SBFD scheme, resources for CSI-RS transmission need to be newly allocated for a slot in which the SBFD scheme is not used and a slot in which the SBFD scheme is used.

Therefore, in an embodiment of the present disclosure, a new scheme for dynamically allocating resources for CSI-RS transmission is proposed in a communication environment that supports simultaneous transmission of downlink and uplink between frequency subbands according to application of the SBFD scheme.

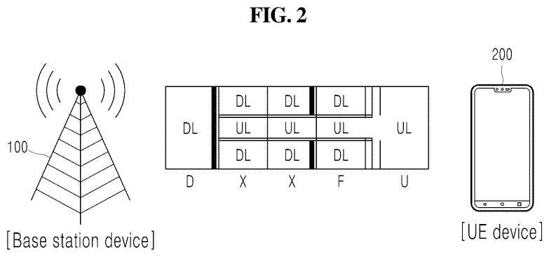

In this regard, FIG. 2 illustrates an example of a full-duplex communication environment based on SBFD according to an embodiment of the present disclosure.

As illustrated in FIG. 2, a full-duplex communication environment based on SBFD according to an embodiment of the present disclosure includes a base station device 100 supporting simultaneous transmission of downlink and uplink between frequency subbands.

The base station device 100 is configured to transmit a CSI-RS to a UE device 200 by using a resource (RE) of a slot supporting simultaneous transmission of downlink and uplink between frequency subbands.

A CSI-RS is essential information that provides reference information serving as a basis for channel estimation, and is transferred to the UE device 200 through the downlink.

In 5G systems, due to various methods for channel estimation and an increase in information, more resources for CSI-RS transmission are required, but the fixed-position resources configured in the existing slot format are insufficient to support this.

In this regard, a method of increasing the resource for CSI-RS transmission may be considered.

However, in such a case that the resource for CSI-RS transmission is continuously increased, the CSI report as feedback therefor may also be increased, which may result in a degradation in communication quality.

Accordingly, in an embodiment of the present disclosure, a method of dynamically allocating a resource for CSI-RS transmission to a UE device 200 that supports simultaneous transmission of downlink and uplink between frequency subbands according to the application of the SBFD scheme is proposed. Hereinafter, the configuration of the base station device 100 and the UE device 200 for implementing the foregoing method will be described in more detail.

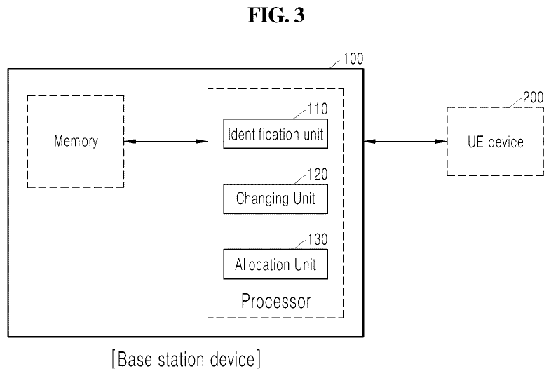

FIG. 3 schematically illustrates the configuration of a base station device 100 according to an embodiment of the present disclosure.

As illustrated in FIG. 3, the base station device 100 according to the embodiment of the present disclosure may include a memory configured to store instructions, and a processor configured to execute the instructions in the memory.

Particularly, the processor according to an embodiment of the present disclosure may have a functional configuration including a changing unit 120 and an allocation unit 130, according to functions implemented by executing instructions.

In addition, the functions implemented by the processor according to an embodiment of the present disclosure may further include the functional configuration of an identification unit 110 in addition to the above-described components.

As described above, the base station device 100 according to an embodiment of the present disclosure may dynamically allocate a resource for CSI-RS transmission through the above-described functional configuration of the processor. Hereinafter, each functional component for realizing the same will be described in more detail.

The identification unit 110 is responsible for a function of identifying whether SBFD is supported.

More specifically, the identification unit 110 may be configured to identify whether the UE device 200 supports simultaneous transmission of downlink and uplink between frequency subbands.

In this case, the identification unit 110 may be configured to identify whether the UE device 200 supports simultaneous transmission of downlink and uplink between frequency subbands, based on capability information reported from the UE device 200.

Such identification of whether simultaneous transmission is supported may be performed whenever camping-on is attempted by the UE device 200.

The changing unit 120 is responsible for a function of changing (determining) a slot format for the UE device 200.

More specifically, when it is identified that the UE device 200 supports simultaneous transmission of downlink and uplink between frequency subbands, the changing unit 120 is configured to change (determine) the slot format of the UE device 200, based on the result of the identification.

In case that the UE device 200 supports simultaneous transmission of the downlink and the uplink between frequency subbands, the changing unit 120 may be configured to change (determine) a slot format according to the classification of a network slice based on a network slicing scheme (5QI/QCI) of the UE device 200.

In this regard, the changing unit 120 may be configured to change a slot format to include at least one of a downlink slot (DL-dedicated slot) for downlink transmission and a simultaneous transmission slot (SBFD slot) ) for simultaneous transmission of downlink and uplink, according to the network slicing scheme of the UE device 200.

To describe this in more detail, the changing unit 120 may be configured to change the slot format to a downlink slot (DL-dedicated slot) following a half-duplex communication scheme, similar to the conventional TDD scheme, or may be configured to maintain the slot format as a simultaneous transmission slot (SBFD slot) according to a full-duplex communication scheme, or may be configured to change the slot format to a combination of a downlink slot (DL-dedicated slot) and a simultaneous transmission slot (SBFD slot).

Here, the change of the slot format according to the full-duplex communication scheme may be performed according to a slicing mode that is classified into a static mode and a dynamic mode.

That is, when the slicing mode is a static mode, the changing unit 120 maintains the slot format as a simultaneous transmission slot (SBFD slot).

On the other hand, when the slicing mode is a dynamic mode, the changing unit 120 selectively applies a downlink slot (DL-dedicated slot) and a simultaneous transmission slot (SBFD slot), based on the presence of a UE device following a network slicing scheme.

In other words, in the case where there is no UE device following the network slicing scheme, the slot format may be changed to a downlink slot (DL-dedicated slot). Thereafter, when a UE following the network slicing scheme is present, the slot format may be changed from a downlink slot (DL-dedicated slot) to a simultaneous transmission slot (SBFD slot) structure.

In addition, as in an embodiment of the present disclosure, in a communication environment supporting simultaneous transmission of downlink and uplink, a structure in which a downlink slot (DL-dedicated slot) and a simultaneous transmission slot (SBFD slot) exist together by having different time domains may be adopted.

For reference, although in an embodiment of the present disclosure the slot format has been described as being changed based on a network slicing scheme, the present disclosure is not limited thereto. For example, the slot format may be changed based on a service identified by a subscriber profile ID (SPID) of the UE device 200, according to a policy determined at a core node.

The allocation unit 130 is responsible for a function of allocating resources for CSI-RS transmission.

More specifically, when a change of the slot format is completed, the allocation unit 130 may be configured to allocate a channel estimation resource, which is a resource for CSI-RS transmission, to a frequency domain for which the downlink is configured in the changed slot format.

In this case, for the changed slot format according to the dynamic mode, instead of allocating without change, as a channel estimation resource, a downlink frequency domain configured at a fixed position in the slot format, the allocation unit 130 may be configured to dynamically allocate different frequency domains for which the downlink is configured based on the data usage of the UE device 200, as channel estimation resources for CSI-RS transmission. Here, the data usage of the UE device 200 may be identified based on whether data allocated to a buffer of specific size (e.g., 0 to 100 bytes) is completely consumed during a pre-defined resource allocation time (e.g., 0 to 5000 ms).

In other words, during the resource allocation time, if data allocated to the buffer is not completely consumed, it may be determined that a larger amount of data needs to be transmitted than the data threshold (buffer size x resource allocation time), and thus, more channel estimation resources may be allocated to the UE device 200.

That is, in case that the data usage of the UE device 200 exceeds a data threshold (buffer size x resource allocation time), the allocation unit 130 may be configured to allocate, as channel estimation resources, a frequency domain of the downlink slot (DL-dedicated slot) and a frequency domain configured for downlink in the simultaneous transmission slot (SBFD slot).

Of course, for the UE device 200 having low data usage, the allocation unit 130 may be configured to allocate, as channel estimation resources, only a frequency domain of some downlink slots (DL-dedicated slots) or only a part of a frequency domain in frequency subbands configured for downlink in a simultaneous transmission slot (SBFD slot).

To this end, for a downlink slot (DL-dedicated slot) for downlink transmission, the allocation unit 130 is configured to allocate, as channel estimation resources, the entire frequency domain of the downlink slot (DL-dedicated slot) on a slot basis. In particular, for a simultaneous transmission slot (SBFD slot) for simultaneous transmission of downlink and uplink, the allocation unit 130 is configured to allocate, as channel estimation resources, a frequency domain of at least one of frequency subbands, in which downlink is configured, on a frequency subband basis within the slot.

On the other hand, for the changed slot format according to the static mode, the allocation unit 130 is configured to allocate without change, as a channel estimation resource, a downlink frequency domain configured at a fixed position in the slot format.

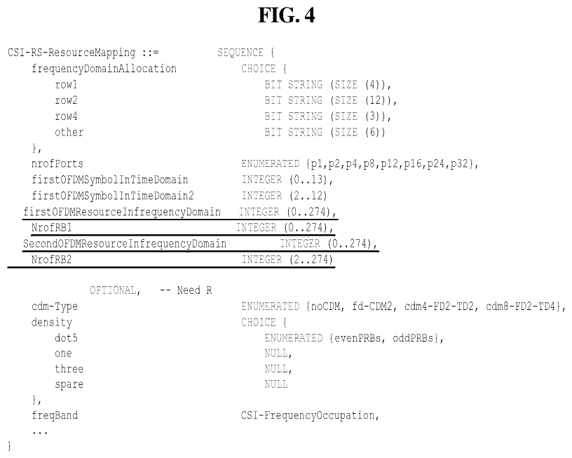

In an embodiment of the present disclosure, a new configuration as exemplified in FIG. 4 is proposed in order to partially allocate channel estimation resources on a frequency subband basis within the slot for a simultaneous transmission slot (SBFD slot) as described above.

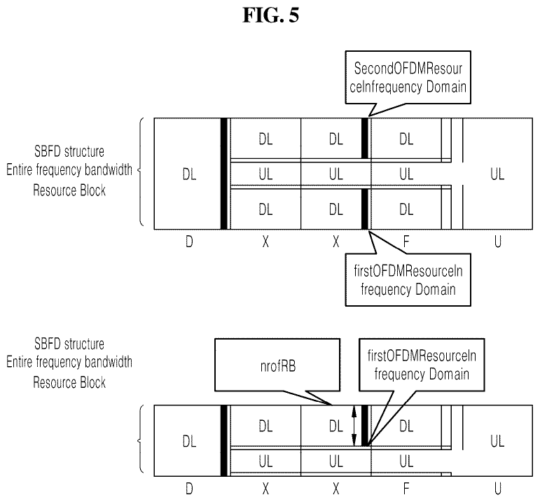

In this regard, a frequency domain for which the downlink is configured in the simultaneous transmission slot (SBFD slot) is divided into a maximum of two frequency domains, for example, as “firstOFDMResourceInfrequencyDomain” and “SecondOFDMResourceInfrequencyDomain” as illustrated in FIG. 5.

Accordingly, in FIG. 4, “firstOFDMResourceInfrequencyDomain INTEGER(0..274)” indicates the allocated position of the first CSI-RS, “NrofRB1 INTEGER(0..274)” indicates the number of resources (RBs) from the allocated position of the first CSI-RS, “SecondOFDMResourceInfrequencyDomain INTEGER(0..274)” indicates the allocated position of the second CSI-RS, and “NrofRB2 INTEGER (2..274)” indicates the number of resources (RBs) from the allocated position of the second CSI-RS.

Based on this, in an embodiment of the present disclosure, if there is a need to partially allocate a channel estimation resource for a simultaneous transmission slot (SBFD slot), it is possible to designate and selectively allocate “firstOFDMResourceInfrequencyDomain” or “SecondOFDMResourceInfrequencyDomain”.

As described above, the allocation unit 130 may be configured to allocate the channel estimation resource by identifying the start position of a frequency subband in which the downlink is configured in a simultaneous transmission slot (SBFD slot), and by configuring the number of resources (RBs) necessary for CSI-RS transmission from the identified start position.

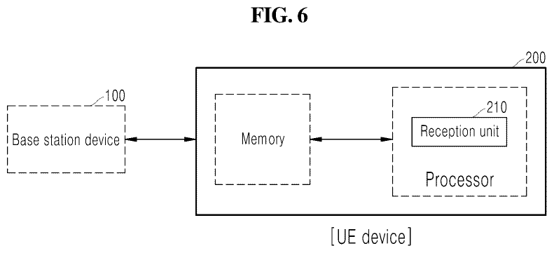

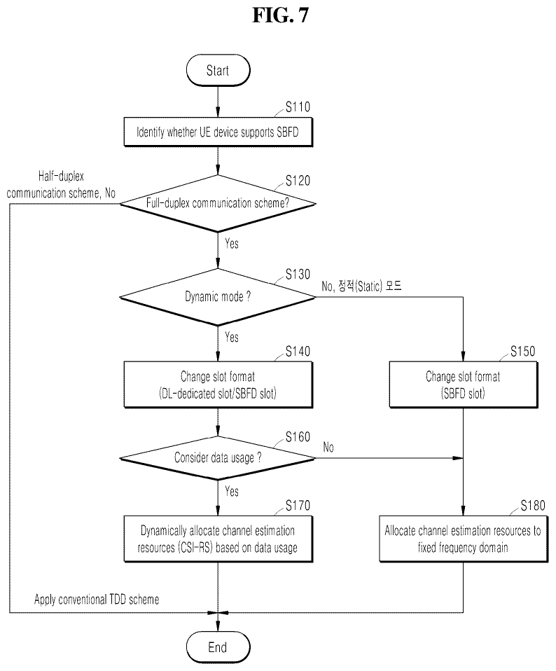

FIG. 6 schematically shows a configuration of the UE device 200 according to an embodiment of the present disclosure.

As illustrated in FIG. 6, a UE device 200 according to an embodiment of the present disclosure may include a memory configured to store instructions and a processor configured to execute the instructions in the memory.

In particular, the processor according to an embodiment of the present disclosure may have a functional configuration including the reception unit 210, according to the functions implemented by executing the instructions.

The UE device 200 according to the above-described embodiment of the present disclosure is able to receive a CSI-RS through a resource dynamically allocated by the base station device 100. Hereinafter, the detailed description will continue regarding each functional element for realizing the above.

The reception unit 210 is responsible for a function of receiving a CSI-RS through a channel estimation resource dynamically allocated by the base station device 100.

More specifically, as simultaneous transmission of downlink and uplink is supported between frequency subbands, when the slot format is changed by the base station device 100 based on a network slicing scheme, the reception unit 210 is configured to receive, through a frequency domain of a downlink configured for the UE device 200 in the changed slot format, the CSI-RS transmitted by the base station device 100.

In this regard, when it is identified whether the UE device 200 supports simultaneous transmission of downlink and uplink between frequency subbands, the base station device 100 is configured to change (determine) a slot format for the UE device 200, based on the result of the identification.

In this case, when the UE device 200 supports the simultaneous transmission of downlink and uplink between frequency subbands, the base station device 100 may be configured to differently change (determine) a slot format according to a network slice classification based on a network slicing (5QI/QCI) scheme of the UE device 200.

To examine this in more detail, the base station device 100 may be configured to change a slot format to include at least one of a downlink slot (DL-dedicated slot) for downlink transmission, and a simultaneous transmission slot (SBFD slot) for simultaneous transmission of downlink and uplink, according to the network slicing scheme of the UE device 200.

In more detail, the base station device 100 may be configured to change the slot format to a downlink slot (DL-dedicated slot) in the same manner as the existing TDD scheme according to a half-duplex (HD) communication scheme, and may also maintain the slot format as a simultaneous transmission slot (SBFD slot) according to a full-duplex (FD) communication scheme, or may change the slot format to a combination of a downlink slot (DL-dedicated slot) and a simultaneous transmission slot (SBFD slot).

Here, a slot format change according to the full duplex communication scheme may be performed according to a slicing mode, which is divided into a static mode and a dynamic mode.

That is, when the slicing mode is a static mode, the base station device 100 maintains the slot format as a simultaneous transmission slot (SBFD slot).

On the other hand, when the slicing mode is a dynamic mode, the base station device 100 is configured to selectively apply a downlink slot (DL-dedicated slot) or a simultaneous transmission slot (SBFD slot) based on the presence or absence of a UE device following a network slicing scheme.

In other words, in the case where there is no UE device following the network slicing scheme, the slot format may be changed to a downlink slot (DL-dedicated slot), and when a UE following the network slicing scheme appears, the slot format may be changed from the downlink slot (DL-dedicated slot) to a simultaneous transmission slot (SBFD slot) structure.

In addition, in a communication environment supporting simultaneous transmission of downlink and uplink, as in an embodiment of the present disclosure, a structure in which a downlink slot (DL-dedicated slot) and a simultaneous transmission slot (SBFD slot) coexist by having different time domains may be adopted.

Furthermore, when a slot format change is completed, the base station device 100 allocates a channel estimation resource, which is a resource for CSI-RS transmission, for a frequency domain for which the downlink is configured in the changed slot format.

In this case, for the changed slot format according to the dynamic mode, instead of allocating without change, as a channel estimation resource, a downlink frequency domain configured at a fixed position in the slot format, the base station 100 may be configured to dynamically allocate different frequency domains for which the downlink is configured based on the data usage of the UE device 200, as channel estimation resources for CSI-RS transmission.

Here, the data usage of the UE device 200 may be identified based on whether data allocated to a buffer of specific size (e.g., 0 to 100 bytes) is completely consumed during a pre-defined resource allocation time (e.g., 0 to 5000 ms).

In other words, during the resource allocation time, if data allocated to the buffer is not completely consumed, it may be determined that a larger amount of data needs to be transmitted than the data threshold (buffer size x resource allocation time), and thus, more channel estimation resources may be allocated to the UE device 200.

In this regard, in case that the data usage of the UE device 200 exceeds the data threshold (buffer size x resource allocation time), the base station 100 may be configured to allocate, as channel estimation resources, a frequency domain of the downlink slot (DL-dedicated slot) and a frequency domain configured for downlink in the simultaneous transmission slot (SBFD slot).

Of course, for the UE device 200 having low data usage, the base station 100 may be configured to allocate, as channel estimation resources, only a frequency domain of some downlink slots (DL-dedicated slots) or only a part of a frequency domain in frequency subbands configured for downlink in a simultaneous transmission slot (SBFD slot).

To this end, for a downlink slot (DL-dedicated slot) for downlink transmission, the base station 100 is configured to allocate, as channel estimation resources, the entire frequency domain of the downlink slot (DL-dedicated slot) on a slot basis. In particular, for a simultaneous transmission slot (SBFD slot) for simultaneous transmission of downlink and uplink, the base station 100 is configured to allocate, as channel estimation resources, a frequency domain of at least one of frequency subbands, in which downlink is configured, on a frequency subband basis within the slot.

On the other hand, for the changed slot format according to the static mode, the base station 100 is configured to allocate without change, as a channel estimation resource, a downlink frequency domain configured at a fixed position in the slot format.

As described above, according to the configuration of the base station device 100 and the UE device 200 according to an embodiment of the present disclosure, with regard to the UE device 200 that supports simultaneous transmission of downlink and uplink between frequency subbands, a slot format is changed based on a network slicing scheme of the UE device 200, and a frequency domain of a downlink configured for the UE device 200 in the slot format based on data usage of the UE device 200 is dynamically allocated as channel estimation resources for CSI-RS transmission. Therefore, it is possible to expect an effect of preventing communication quality degradation due to an increase in CSI reports, and a reduction in power consumption of the base station device 100 and the UE device 200, due to efficient resource utilization.

Hereinafter, a dynamic resource allocation method according to an embodiment of the present disclosure will be described with reference to FIG. 7.

For the sake of descriptive convenience, the base station device 100 described with reference to FIG. 2 will be mentioned as the performer of the dynamic resource allocation method in the following description.

First, the base station device 100 is configured to identify whether the UE device 200 supports simultaneous transmission of downlink and uplink between frequency subbands (S110).

In this case, the base station device 100 may identify whether the corresponding UE device supports simultaneous transmission of downlink and uplink between frequency subbands, based on information on a capability reported from the UE device 200, and this may be performed whenever camping-on is attempted by the UE device 200.

Thereafter, when it is identified whether or not simultaneous transmission of downlink and uplink between frequency subbands is supported for the UE device 200, the base station device 100 is configured to change (determine) a slot format for the UE, based on the result of the identification.

In this case, when the UE device 200 supports simultaneous uplink and downlink transmission between frequency subbands, the base station device 100 may be configured to change (determine) a slot format differently according to network slice classification based on a network slicing scheme (5QI/QCI) of the UE device 200.

In this regard, the base station device 100 may be configured to change the slot format to include at least one of a downlink slot (DL-dedicated slot) for downlink transmission and a simultaneous transmission slot (SBFD slot) slot) for simultaneous transmission of downlink and uplink, according to the network slicing scheme of the UE device 200.

To describe in more detail, the base station device 100 may be configured to change the slot format to a downlink slot (DL-dedicated slot) in the same manner as the existing TDD scheme, in accordance with a half-duplex (HD) communication scheme. In addition, the base station device 100 may be configured to maintain the slot format as a simultaneous transmission slot (SBFD slot) in accordance with a full-duplex (FD) communication scheme, or may be configured to change the slot format to a combination of a downlink slot (DL-dedicated slot) and a simultaneous transmission slot (SBFD slot) (S120 to S150).

Here, the slot format change according to the full duplex communication scheme may be performed according to a slicing mode, which is divided into a static mode and a dynamic mode.

That is, when the slicing mode is a dynamic slicing mode, the base station device 100 selectively applies a downlink slot (DL-dedicated slot) and a simultaneous transmission slot (SBFD slot), based on the presence or absence of a UE device following a network slicing scheme.

In other words, when there is no UE that follows the network slicing scheme, the slot format may be changed to a DL-dedicated slot, and when a UE that follows the network slicing scheme appears, the slot format may be changed from a downlink slot (DL-dedicated slot) to a simultaneous transmission slot (SBFD slot) structure.

In the communication environment supporting simultaneous transmission of downlink and uplink, as in an embodiment of the present disclosure, a structure in which a downlink slot (DL-dedicated slot) and a simultaneous transmission slot (SBFD slot) may coexist by having different time domains may be adopted.

On the other hand, in case that the slicing mode is a static mode, the base station device 100 is configured to maintain a slot format as a simultaneous transmission slot (SBFD slot).

For reference, in an embodiment of the present disclosure, the slot format has been described as being changed according to a network slicing scheme, but the present disclosure is not limited thereto. It is obvious that the slot format may be changed, for example, based on a service identified by a subscriber profile ID (SPID) of the UE device 200, according to a policy determined at a core node.

Thereafter, when the change of the slot format is completed, the base station device 100 allocates a channel estimation resource that is a resource for CSI-RS transmission, with regard to a frequency domain for which the downlink is configured in the changed slot format.

Here, for the changed slot format according to the dynamic mode, instead of allocating without change, as a channel estimation resource, a downlink frequency domain configured at a fixed position in the slot format, the base station 100 may be configured to dynamically allocate different frequency domains for which the downlink is configured based on the data usage of the UE device 200, as channel estimation resources for CSI-RS transmission (S160 to S170).

In this regard, the data usage of the UE device 200 may be identified based on whether data allocated to a buffer of specific size (e.g., 0 to 100 bytes) is completely consumed during a pre-defined resource allocation time (e.g., 0 to 5000 ms).

In other words, during the resource allocation time, if data allocated to the buffer is not completely consumed, it may be determined that a larger amount of data needs to be transmitted than the data threshold (buffer size x resource allocation time), and thus, more channel estimation resources may be allocated to the UE device 200.

For example, in case that the data usage of the UE device 200 exceeds the data threshold (buffer size x resource allocation time), the base station 100 may be configured to allocate, as channel estimation resources, a frequency domain of the downlink slot (DL-dedicated slot) and a frequency domain configured for downlink in the simultaneous transmission slot (SBFD slot).

Of course, for the UE device 200 having low data usage, the base station 100 may be configured to allocate, as channel estimation resources, only a frequency domain of some downlink slots (DL-dedicated slots) or only a part of a frequency domain in frequency subbands configured for downlink in a simultaneous transmission slot (SBFD slot).

To this end, for a downlink slot (DL-dedicated slot) for downlink transmission, the base station 100 is configured to allocate, as channel estimation resources, the entire frequency domain of the downlink slot (DL-dedicated slot) on a slot basis. In particular, for a simultaneous transmission slot (SBFD slot) for simultaneous transmission of downlink and uplink, the base station 100 is configured to allocate, as channel estimation resources, a frequency domain of at least one of frequency subbands, in which downlink is configured, on a frequency subband basis within the slot.

In an embodiment of the present disclosure, a new configuration as exemplified in FIG. 4 above is proposed in order to partially allocate channel estimation resources on a frequency subband basis within the slot for such a simultaneous transmission slot (SBFD slot).

In this regard, the frequency domain for which the downlink is configured in the simultaneous transmission slot (SBFD slot) is divided into a maximum of two frequency domains, as in the example above, as “firstOFDMResourceInfrequencyDomain” and “SecondOFDMResourceInfrequencyDomain” in FIG. 5.

Accordingly, in the example of FIG. 4 above, “firstOFDMResourceInfrequencyDomain INTEGER(0..274)” indicates the allocation position of the first CSI-RS, “NrofRB1 INTEGER(0..274)” indicates the number of resources (RBs) from the allocation position of the first CSI-RS, “SecondOFDMResourceInfrequencyDomain INTEGER(0..274)” indicates the allocation position of the second CSI-RS, and “NrofRB2 INTEGER(2..274)” indicates the number of resources (RBs) from the allocation position of the second CSI-RS.

Based on this, in an embodiment of the present disclosure, when it is necessary to partially allocate a channel estimation resource for a simultaneous transmission slot (SBFD slot), it is possible to specify “firstOFDMResourceInfrequencyDomain” or “SecondOFDMResourceInfrequencyDomain” to selectively allocate the same.

As described above, the base station device 100 may be configured to allocate a channel estimation resource by specifying the starting position of the frequency subband in which downlink is configured in the simultaneous transmission slot (SBFD slot), and by configuring the number of resources (RBs) necessary for CSI-RS transmission from the specified starting position.

On the other hand, for the change slot format according to the static mode, the base station device 100 may be configured to allocate without change, as a channel estimation resource, a downlink frequency domain configured at a fixed position in the slot format (S180).

As described above, according to the dynamic resource allocation method according to an embodiment of the present disclosure, with regard to the UE device 200 supporting simultaneous transmission of downlink and uplink between frequency subbands, a slot format is changed based on a network slicing scheme of the UE device 200, and a frequency domain of a downlink configured for the UE device 200 in the slot format is dynamically allocated, based on the data usage of UE device 200, as channel estimation resources for CSI-RS transmission. Accordingly, the resource is efficiently utilized, and thus, effects such as preventing degradation of communication quality caused by an increase in CSI report, and reduction in power consumption of the base station device 100 and the UE device 200 may be expected.

A dynamic resource allocation method according to an embodiment of the present disclosure may be implemented in the form of program instructions executable through various computer means and may be recorded in a computer-readable medium. The computer-readable medium may include, alone or in combination, program instructions, data files, data structures, etc. The program instructions recorded on the medium may be those specially designed and configured for the present disclosure, or may be those well-known and available to a computer software expert. Examples of the computer-readable recording medium may include magnetic media such as a hard disk, a floppy disk, and a magnetic tape, optical recording media such as a CD-ROM and a DVD, magneto-optical media such as a floptical disk, and hardware devices especially configured to store and execute program instructions, such as a ROM, a RAM, and a flash memory. The program instructions may include machine code such as that produced by a compiler as well as high-level language code which may be executed by a computer using an interpreter or the like. The hardware device may be configured to operate as one or more software modules to perform the operations of the present disclosure, and vice versa.

Although the present disclosure has been described in detail with reference to the preferred embodiments, the present disclosure is not limited to the above-described embodiments, and the technical idea of the present disclosure may be extended to a scope in which various modifications or revisions may be made by those skilled in the art to which the present disclosure pertains without departing from the subject matter of the present disclosure as set forth in the following claims.

### INDUSTRIAL APPLICABILITY

According to the UE device of the present disclosure, in connection with a subband non-over lapping full duplex (SBFD) technology, in a communication environment in which simultaneous transmission of a downlink and an uplink is supported between frequency subbands, resources for CSI-RS transmission can be dynamically allocated. In this respect, the present disclosure overcomes the limitations of the conventional technology. As it is not merely utilizable in related technologies but also readily applicable to commercially available or operable devices, the present disclosure is evidently practicable and therefore industrially applicable.

What is claimed is:

1. A terminal device comprising:
a memory configured to store instructions; and
a processor configured to execute the instructions to, as simultaneous transmission of downlink and uplink between frequency subbands is supported, when a slot format is changed by a base station device based on a network slicing scheme of the terminal device, receive a CSI-RS transmitted by the base station device through a channel estimation resource configured in a downlink frequency domain in the slot format.

2. The terminal device of claim 1, wherein, for the terminal device, the slot format comprises at least one of a downlink slot for downlink transmission and a simultaneous transmission slot for simultaneous transmission of downlink and uplink.

3. The terminal device of claim 2, wherein the channel estimation resource is allocated, for the downlink slot, to an entire frequency domain of the downlink slot on a slot basis, and is allocated, for the simultaneous transmission slot, to a frequency domain for which the downlink is configured on a frequency subband basis within the slot.

4. The terminal device of claim 3, wherein the channel estimation resource is allocated in a manner of specifying a starting position of a frequency subband in which downlink is configured in the simultaneous transmission slot, and configuring the number of resources (RBs) required for CSI-RS transmission from the specified starting position.

5. The terminal device of claim 2, wherein the channel estimation resource is allocated, based on data usage of the terminal device, to different frequency domains for which the downlink is configured in the slot format, and
in case that the data usage amount exceeds a threshold, the channel estimation resource is allocated to an entire frequency domain including downlinks of the downlink slot and the simultaneous transmission slot.
